(19) United States
(12) Patent Application Publication
(10) Pub. No.: US 2018/0232002 A1
(43) Pub. Date: Aug. 16, 2018

(54) Active Vibratory Pedal with Haptic Motor Power Connection Assembly

(71) Applicant: CTS Corporation, Lisle, IL (US)

(72) Inventors: Steven Brown, Whitbum (GB); Gerard McCafferty, Glasgow (GB); Stephen Debon, Edinburgh (GB)

(73) Assignee: CTS Corporation, Lisle, IL (US)

(21) Appl. No.: 15/895,168

(22) Filed: Feb. 13, 2018

Related U.S. Application Data
(60) Provisional application No. 62/458,756, filed on Feb. 14, 2017.
(60) Provisional application No. 62/458,765, filed on Feb. 14, 2017.

(51) Int. Cl. G05G 1/40; G05G 1/44; G05G 1/38; G05G 5/03

(52) U.S. Cl. CPC G05G 1/40; G05G 1/44; B60K 2026/022; G05G 5/03; G05G 1/38

(57) ABSTRACT

An active vibratory pedal comprising a pedal housing and a pedal housing cover. A pedal arm extends into the pedal housing. An electric vibratory motor is mounted on the pedal arm. A power cable extends from the motor into the end of the pedal arm extending into the pedal housing. A motor power connection assembly includes, in one embodiment, electrical contactors coupled to the end of the power cable and located in an open recess defined in the drum of the pedal arm. Conductive tracks are formed on the cover of the pedal housing. The contactors are in sliding contact with the contactor tracks. Power connection terminals extend through the cover and into electrical contact with the conductive tracks. In another embodiment, terminals extend through the cover and into electrical contact with the end of the power cable extending into the open recess defined in the drum of the pedal.

### CROSS-REFERENCE TO RELATED APPLICATIONS

This patent application claims priority and benefit of the filing date of U.S. Provisional Patent Application Ser. No. 62/458,756 filed on Feb. 14, 2017 and U.S. Provisional Patent Application Ser. No. 62/458,765 filed on Feb. 14, 2017, the disclosure and contents of which are expressly incorporated herein in their entireties by reference.

### FIELD OF THE INVENTION

The present invention relates generally to an active vibratory pedal and, in particular, to an active vibratory pedal with an assembly for connecting and transmitting power to the haptic motor.

### BACKGROUND OF THE INVENTION

Vehicle accelerator/throttle pedals allow a vehicle operator to control the acceleration of a vehicle through either the application or removal of a foot force on the pedal. Pedals have been developed that provide a haptic/vibratory feedback to the operator in response to the sensing of a variety of vehicle conditions or events including, for example, the vehicle exceeding a recommended speed, or the vehicle not keeping a safe distance behind another vehicle, or the vehicle sensing the presence of an object behind the vehicle when operating in reverse.

U.S. Pat. No. 9,582,024 to Brown et al., the contents and disclosure of which are expressly incorporated herein by reference, discloses one embodiment of an active vibratory pedal with a haptic vibratory motor mounted to the underside of the pedal and adapted to generate and apply a vibration to the pedal in response to the sensing of vehicle conditions.

The present invention is directed to an assembly for connecting and transferring power from an external power source to the haptic motor in a vibratory pedal of the type disclosed in U.S. Pat. No. 9,582,024 to Brown et al.

### SUMMARY OF THE INVENTION

The present invention is generally directed to an active vibratory pedal comprising a pedal housing, a pedal housing cover, a rotatable pedal arm including a first end extending into the pedal housing, an electric vibratory motor mounted on the pedal arm, an electric motor power cable extending from the electric motor and into the first end of the pedal arm, and a motor power connection assembly extending between the first end of the pedal arm and the pedal housing cover.

In one embodiment, the motor power connection assembly comprises electrical contactors coupled to the electric motor power cable and located in the first end of the pedal arm, electrically conductive tracks formed on the cover of the pedal housing, the electrical contactors being in sliding contact with the conductive tracks, and an electrical connector housing on the cover including terminals in electrical contact with the conductive tracks.

In one embodiment, the pedal arm includes a drum defining an open recess, the electrical contactors being located in the open recess in the drum.

In one embodiment, the haptic motor power connection assembly further comprises a contactor cartridge, the electrical contactors being located in the contactor cartridge and the contactor cartridge extending into the open recess in the drum of the pedal arm.

In one embodiment, a printed circuit board on the cover, the conductive tracks being formed on the printed circuit board and the terminals extending into the printed circuit board.

In one embodiment, the pedal includes a collar on the cover, the printed circuit board being located on the collar and the collar extending into the open recess defined in the drum of the pedal arm with the electrical contactors in sliding contact against the respective conductive tracks.

In one embodiment, the motor power connection assembly includes electrical terminals coupled to the end of the motor power cable located in the first end of the pedal arm and extending through through-holes defined in the pedal housing cover.

In one embodiment, the pedal arm includes a drum defining an open recess, the end of the motor power cable and the electrical terminals being located in the open recess in the drum.

The present invention is also directed to an active vibratory pedal comprising a pedal housing, a pedal housing cover, a rotatable pedal arm including a first end extending into the pedal housing, an electric vibratory motor mounted on the pedal arm, an electric motor power cable extending from the electric motor into the first end of the pedal arm, and a motor power connection assembly comprising electrical contactors coupled to the electric motor power cable and located in the first end of the pedal arm, electrical conductive tracks formed on the cover of the pedal housing, the electrical contactors being in sliding contact with and against the respective conductive tracks in response to the rotation of the pedal arm, and electrical terminals on the cover in electrical contact with the conductive tracks.

In one embodiment, the pedal arm includes a drum defining an open recess, the electrical contactors being located in the open recess in the drum.

In one embodiment, the haptic motor power connection assembly further comprises a contactor cartridge, the electrical contactors being located in the contactor cartridge and the contactor cartridge extending into the open recess in the drum of the pedal arm.

In one embodiment, a printed circuit board is on the cover, the conductive tracks being formed on the printed circuit board and the terminals extending into the printed circuit board.

In one embodiment, a collar is on the cover, the printed circuit board being located on the collar and the collar extending into the open recess defined in the drum of the pedal arm with the electrical contactors in sliding contact with the respective conductive tracks.

The present invention is further directed to an active vibratory pedal comprising a pedal housing, a rotatable pedal arm including a first end extending into the pedal housing, an electric vibratory motor mounted on the pedal arm, a electrical power connection cable extending from the electric motor and including an end extending into the first end of the pedal arm, and a motor power connection assembly including a pedal housing cover including terminals extending therethrough and coupled to the end of the power connection cable extending into the first end of the pedal arm.

In one embodiment, the pedal arm includes a drum defining an open recess, the end of the motor power cable and the terminals extending into the open recess in the drum.

Other advantages and features of the present invention will be more readily apparent from the following detailed description of the embodiments of the invention, the accompanying drawings, and the appended claims.

### BRIEF DESCRIPTION OF THE DRAWINGS

These and other features of the invention can best be understood by the following description of the accompanying FIGS:

FIG. 1 is a perspective view of an active vibratory pedal with a haptic motor power connection assembly in accordance with the present invention;

FIG. 2 is another perspective view of the active vibratory pedal shown in FIG. 1;

FIG. 3 is an exploded perspective view of the active vibratory pedal shown in FIG. 1;

FIG. 4 is an enlarged broken perspective view of the electrical conductive track structure on a collar on one of the covers of the active vibratory pedal;

FIG. 5 is an enlarged broken exploded perspective view depicting the drum of the pedal arm and the contactor cartridge assembly of the haptic motor power connection assembly of the present invention;

FIG. 5A is an enlarged perspective view of one of the contactors shown in FIG. 5;

FIG. 6 is an enlarged broken perspective view of the contactor cartridge assembly of the haptic motor power connection assembly of the present invention located in the interior of the drum of the pedal arm of the active vibratory pedal;

FIG. 7 is a broken vertical cross-sectional view of the haptic motor power connection assembly of the active vibratory pedal shown in FIGS. 1 and 2;

FIG. 8 is an exploded perspective view of the active vibratory pedal shown in FIG. 1 incorporating another embodiment of a haptic motor power connection assembly in accordance with the present invention;

FIG. 9 is a broken part perspective part cross-sectional view of the drum of the pedal arm of the active vibratory pedal shown in FIG. 8 depicting the ends of the haptic motor power cable extending through the interior of the drum of the pedal arm;

FIG. 10 is an enlarged perspective view of the electrical connectors of the haptic motor power connection assembly of the active vibratory pedal shown in FIG. 8;

FIG. 11 is a broken part perspective part cross-sectional view of the drum of the pedal arm of the active vibratory pedal shown in FIG. 8 depicting the electrical connectors coupled to the ends of the haptic motor power cable extending through the interior of the drum of the pedal arm;

FIG. 12 is an enlarged broken perspective view of the connector housing on the cover of the active vibratory pedal shown in FIG. 8; and

FIG. 13 is a vertical cross-sectional view of the haptic motor power connection assembly of the active vibratory pedal shown in FIG. 8.

### DETAILED DESCRIPTION OF THE EMBODIMENT

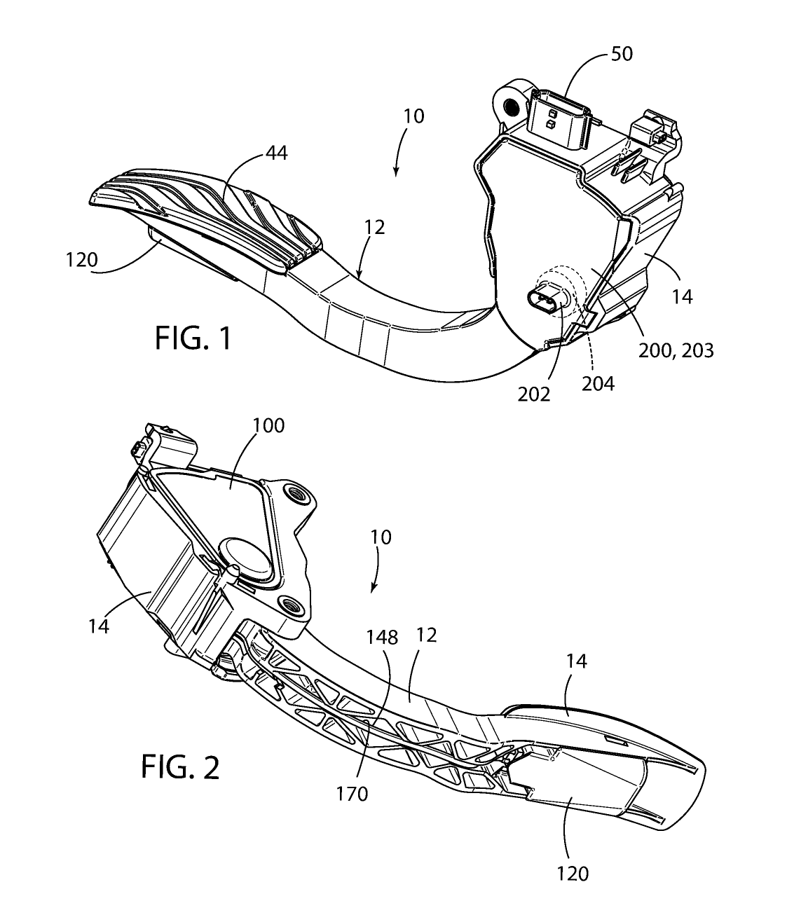

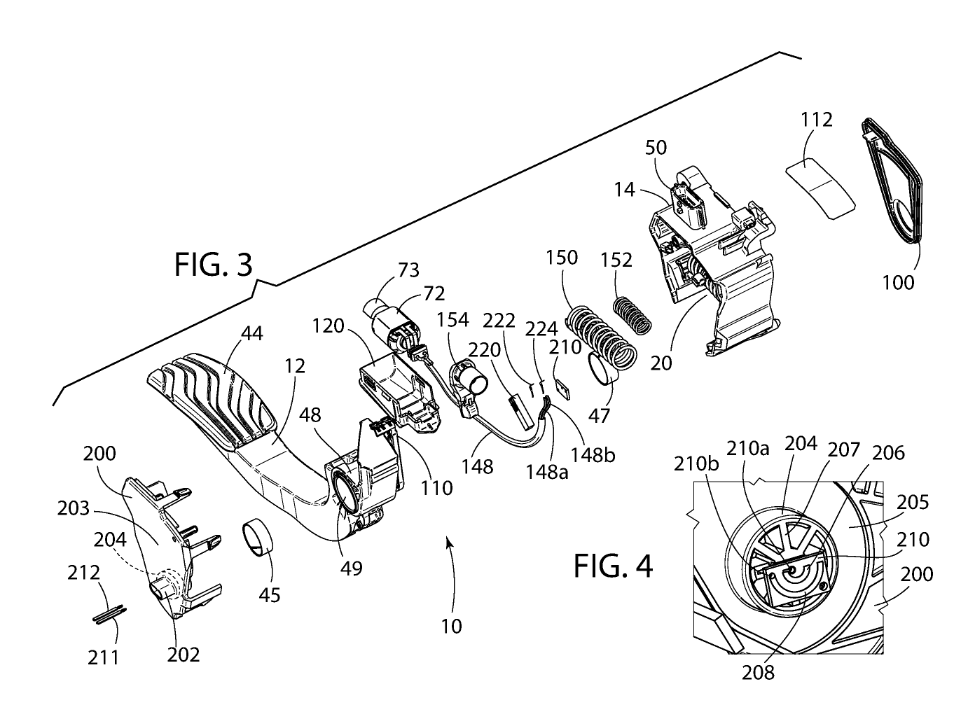

FIGS. 1 through 7 depict a vehicle active or haptic vibratory pedal 10 incorporating a haptic motor power assembly in accordance with the present invention.

The vehicle pedal 10, which is of the type disclosed in U.S. Pat. No. 9,582,024, the contents of which are incorporated herein by reference, comprises a pedal arm 12 and a housing 14 for the pedal arm 12 which may both be made and molded of any suitable plastic material.

The housing 14 includes a plurality of exterior walls together defining an interior housing cavity 20.

The housing 14 further comprises a first cover 100 and a second cover 200 that cover opposed sides of the housing 14 and, more specifically, covers 100 and 200 that cover the interior cavity 20 of the housing 14 with the exception of a front housing opening in open communication with the interior cavity 20.

The pedal arm 12 includes a foot pad or plate 44 at one end and a drum 48 at the other end which extends through the front housing opening and into the interior cavity 20 of the housing 14.

The drum 48 is mounted in the interior cavity of the housing 14 in a relationship adapted for rotational movement relative to the housing 14 via interior bearings 45 and 47 thus mounting the pedal arm 12 for both counterclockwise and clockwise movement to cause the acceleration and deceleration of a vehicle.

The drum 48 of the pedal arm 12 includes and defines an interior cylindrical recess or cavity 49 defined in one of the side faces thereof which opens into an interior rectangular shaped slot or cavity 51 which in turn is in open communication with a through-hole or aperture 53 extending through an exterior circumferential wall 55 of the drum 48 which in turn opens into an elongate interior cable track or recess 170 defined in and extending along the underside of the pedal arm 12 between the opening 53 and the haptic motor 72.

In the embodiment shown, the assembly for sensing the position of the pedal arm 12 is of the contacting potentiometer type shown and described in detail in for example U.S. Pat. No. 8,042,430 to Campbell, the contents and description of which is are incorporated herein by reference and including for example and as shown in FIG. 2 an electrical contact wiper arm 110 in the interior housing cavity 20 which is coupled to the drum 48 and includes contacts at the distal end thereof adapted for sliding contact with a film or strip of conductive material film 112 also located in the interior housing cavity 20 in response to the rotation of the pedal arm 12 and the drum 48. An electrical position sensor connector housing 50 protrudes unitarily outwardly from the exterior surface of the top wall of the housing 14 and is adapted for connection to a wire harness (not shown) and a vehicle control module (not shown) for controlling a vehicle's acceleration/deceleration in response to electrical signals generated by the sensor assembly.

Although not show in any of the FIGS., it is understood that the assembly for sensing the position of the pedal arm 12 may be of any other suitable type including for example the non-contacting Hall Effect sensor type disclosed in for example U.S. Pat. No. 7,926,384 to Wurn, the contents and description of which is incorporated herein by reference.

The pedal 10 still further comprises a pedal hysteresis assembly of the type known in the art and including, for example and as shown in FIG. 2, a plurality of springs 150 and 152 in the interior housing cavity 20 adapted for cooperation with the drum 48 of the pedal arm 12 and a hysteresis member 154 adapted to cooperate with the springs 150 and 152 and the drum 48.

The pedal 10 further comprises a haptic/vibration generation motor 72 which is fully integrated on and with the pedal 12 and is via an eccentric 73 adapted to generate and transfer a vibration/haptic force to the pedal arm 12 in response to the activation of the motor 72 as described in U.S. Pat. No. 9,582,024 to Brown et al., the contents and description of which are incorporated herein by reference.

In the embodiment shown, the motor 72 is secured to the underside of the pedal arm 12 and, more specifically, to the underside of the foot plate 44. An elongate power connection cable 148 extends from the motor 72 along and through the elongate cable track 170 defined in and extending into and through the coring of the plastic material on the underside of the pedal arm 12 and into electrical coupling relationship with the haptic motor power connection assembly of the present invention as described in more detail below.

The haptic motor power connection assembly is comprised initially of the pedal housing cover plate 200 which includes a haptic motor power connector/terminal housing 202 protruding outwardly from an exterior face 203 thereof and defining an interior cavity for electrical terminals 211 and 212.

Although not shown in any of the FIGS, it is understood that an external electrical power transmission cable is adapted for coupling to the connector housing 202 on the cover plate 200 of the pedal 10 and, more specifically for connection to the terminals 211 and 212 in the interior of the terminal housing 202.

The pedal housing cover plate 200 additionally includes a cylindrical pedal drum support bearing or collar 204 protruding outwardly from an interior face 205 opposed to the exterior face 203 thereof. The collar 204 and the housing 202 are located on the respective faces 205 and 203 in a co-linear relationship relative to each other.

The haptic motor power connection assembly still further comprises a pair of generally semi-circular shaped and spaced apart electrical and curvilinear shaped contactor tracks or tracks/strips of electrically conductive material 206 and 208 formed on the exterior surface of a printed circuit board or substrate 210 mounted on a radial end face 207 of the interior collar 204 on the interior face 205 of the cover plate 200.

The haptic motor power assembly still further comprises a pair of metal electrical terminals 211 and 212 extending through the interior of the connector housing 202, the cover plate 200, and terminating in respective ends 211a and 212a extending into and coupled to respective conductive through vias 210a and 210b defined in and extending through the interior of the printed circuit board 210. The vias 210a and 210b in turn are in electrical coupling relationship with the electrically conductive material of the respective conductive tracks 206 and 208.

The haptic motor power assembly still further comprises a contactor cartridge or box 220 which may be made of a plastic material and defines an open interior that houses a pair of metal electrical contactors 222 and 224 and the ends 148a and 148b of the cable 148 as described in more detail below.

Each of the electrical contactors 222 and 224 includes a first contactor end 226 in sliding contact with and against the surface of the respective conductive contactor tracks 206 and 208 and an opposed cable coupling end 228 coupled to respective ends of the wire harness/power cable 148 of the haptic motor 72.

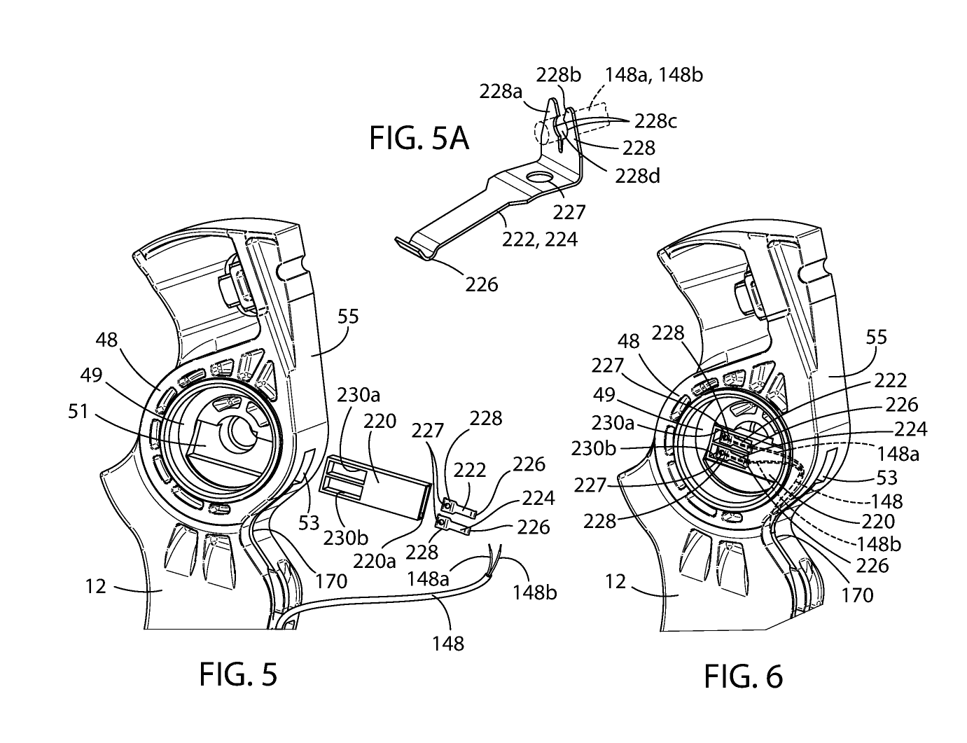

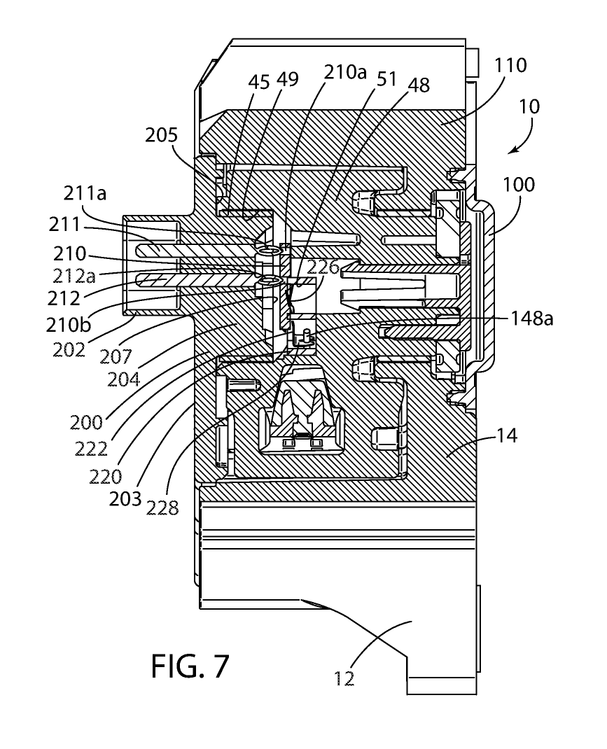

In the embodiment shown, the first end 226 of each of the respective contactors 222 and 224 is generally hook-shaped and includes a curved exterior surface adapted for contact with the respective conductive tracks 206 and 208 while the end 228 of each of the respective contactors 222 and 224 defines a spade opening including a pair of spaced apart fingers or prongs 228a and 228b each defining an interior curved surface 228c together defining a circular opening 228d adapted to cut through the coating of the ends 148a and 148b of the power cable 148 to make contact with the interior copper layers of the power cable 148 and retain the ends 148a and 148b of the cable 148 on the end 228 of the respective contactors 222 and 224 as shown in FIGS. 5A and 7.

Each of the pair of contactors 222 and 224 additionally defines a through-hole 227 that allows the pair of contactors 222 and 224 to be heat stacked in the interior of the contactor cartridge 220 into the relationship as shown in FIG. 6 with the respective contactors 222 and 224 protruding through respective windows or openings 230a and 230b defined at one end of the contactor cartridge 220 and the ends 148a and 148b of the cable 148 in electrical coupling relationship with the respective ends 228 of the respective contactors 222 and 224.

Thus, in accordance with the present invention, the elements of the haptic pedal power connection assembly are associated with and coupled to each other and the power cable 148 of the haptic motor 72 as described below in more detail.

Initially, the ends 148a and 148b of the haptic power cable 148 are inserted and located in the interior of the cartridge 220 through the opening 220a defined in the end of the cartridge 220 and are coupled to the respective ends 228 of the respective contactors 222 and 224 with the respective contactors 222 and 224 located in the respective windows 230a and 230b of the cartridge 220 and heat stacked to the cartridge 220.

Thereafter, the contactor cartridge 220 is inserted into and extended through the elongate slot 53 defined in the exterior surface of the drum 48 and into the interior drum recess 49 into the relationship as shown in FIG. 6 with the cartridge openings 230a and 230b in open communication with the interior drum recess 49 and thus into the relationship as shown in FIG. 6 with the respective contactors 222 and 224, and still more specifically with the contactor ends 226 of the respective contactors 222 and 224, located in the interior drum cavity 49.

Thereafter, the pedal arm 12 and, more specifically, the drum 48 thereof is inserted into the interior cavity of the pedal housing 14 through the opening therein into the position as shown in FIGS. 1 and 2.

Thereafter, the pedal housing cover 200 is positioned and clipped to the one of the sides of the pedal housing 14 into the relationship as shown in FIGS. 1 and 7 with the collar 204 thereon extending into the recess 49 defined in the side of the drum 40 and still more specifically into a relationship with the respective ends 226 of the respective contactors 222 and 224 in the contactor cartridge 220 in abutting sliding contact relationship with the respective contactor tracks 206 and 208 formed on the board 210 mounted on the radial end face 207 of the collar 204 and further into a relationship with the respective ends 211a and 212a of the respective terminals 211 and 212 extending through the terminal/conductor housing 202, the cover 200, the collar 204, and into the respective vias 210a and 210b in the substrate 210 on the collar 204.

In accordance with the present invention, the collar 204 serves the dual purpose of defining a bearing support for the drum 48 and the pedal arm 12 and also defining an electrical connection hub between the drum 48 and the cover 200 for the haptic motor 72.

Thus, in accordance with the present invention, electrical power is supplied to the haptic motor 72 via the external power cable (not shown) which is adapted for connection to the terminal/connector housing 202, through the terminals 211 and 212 located in the interior of the connector housing 202 and including ends 211a and 212a extending through and in electrical coupling relationship with the respective vias 210a and 210b in the substrate 210, through the connector tracks 206 and 208 in electrical coupling relationship with the vias 210a and 210b, through the end 226 of the contactors 222 and 224 in sliding abutting contact with the respective contactor tracks 206 and 208, through the respective contactors 226, through the end 228 of the respective contactors 226 coupled to the respective ends 148a and 148b of the haptic motor cable 148, and then through the power connection cable 148 and into the haptic motor 72 to activate the vibratory motor 72.

In accordance with the present invention, the combination of a cover bearing or collar 204 with fixed/stationary conductive tracks 206 and 208 and a rotatable pedal arm 12 incorporating contactors 222 and 224 adapted for sliding contact with and against the conductive tracks 206 and 208 allows and provides for the continuous and uninterrupted connection and transmission of electrical power to the haptic motor 70 notwithstanding the rotation of the pedal arm 12 relative to the pedal housing 14.

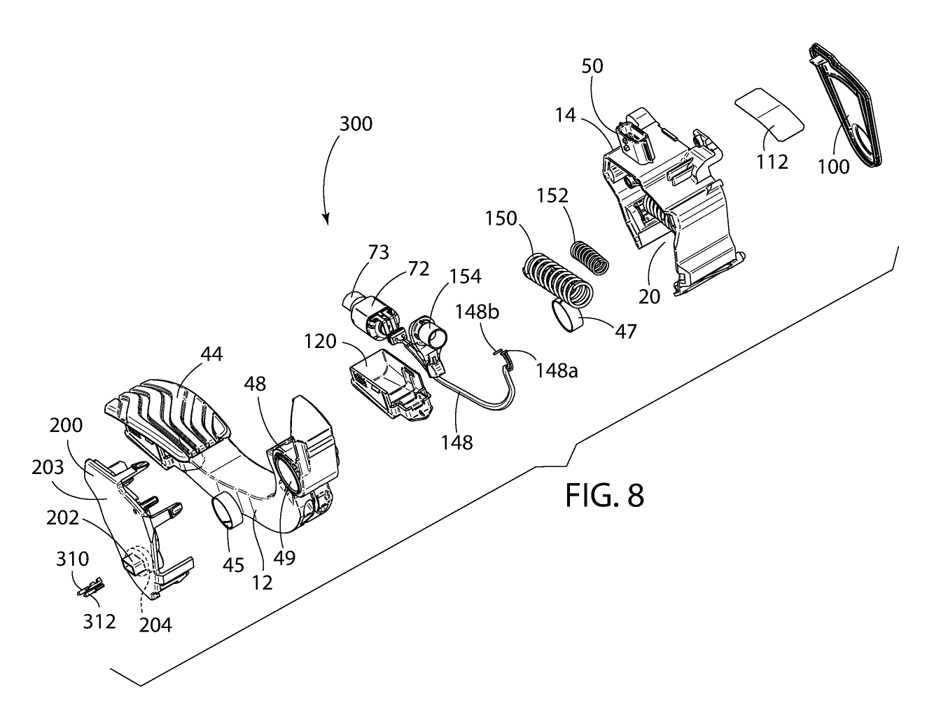

FIGS. 8 through 13 depict an active vibratory pedal 300 incorporating another embodiment of a haptic motor power connection assembly in accordance with the present invention.

A majority of the elements and components of the active vibratory pedal 300 are identical to the active vibratory pedal 10 shown in FIGS. 1 through 7 and described above and thus the same numbers are used in FIGS. 8 through 13 for such elements and components and the earlier description in regard to such elements or components is incorporated herein by reference with regard to the description of the elements and components of the active vibratory pedal 300.

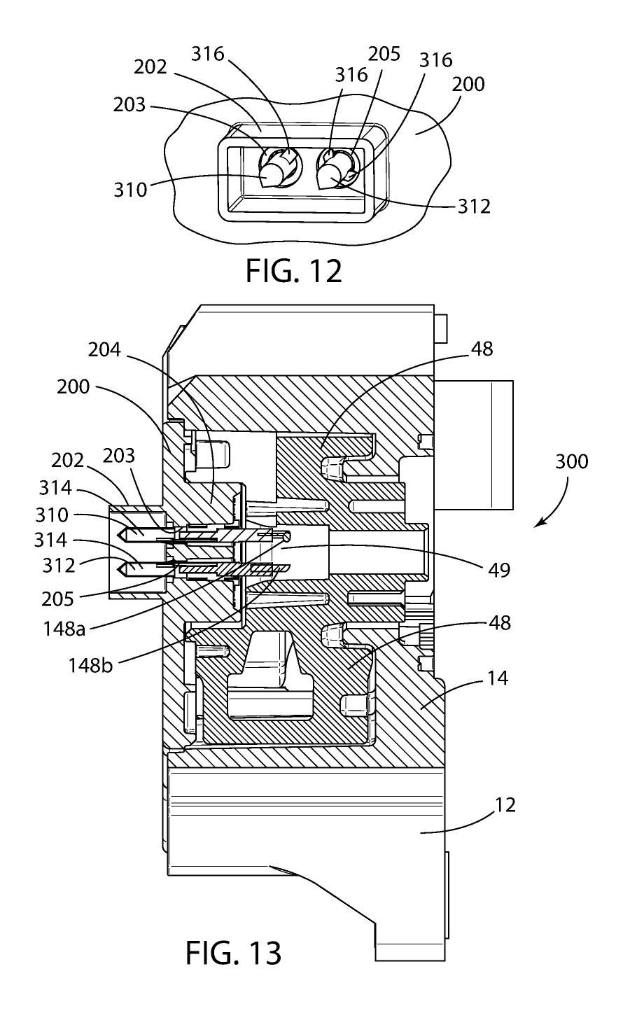

The haptic motor power connection assembly in accordance with the present invention initially comprises the pedal housing cover plate 200 including the haptic motor power terminal/connector housing 202 protruding unitarily outwardly from the exterior surface thereof. A pair of terminal/connector receiving through-holes 203 and 205 are defined in and extend through the interior of the terminal/connector housing 202, the cover plate 200, and the collar 204 as shown in FIGS. 12 and 13.

The haptic motor power connection assembly also comprises a pair of terminals/connectors 310 and 312 that extend through the interior of the terminal/connector housing 202, through the respective through-holes 203 and 205 in the cover plate 200 and the collar 204 and into electrical coupling relationship with the respective ends 148a and 148b of the power connection cable 148 located in the interior cavity 49 of the drum 48 of the pedal arm 12 as discussed in more detail below.

Each of the terminals/connectors 310 and 312 includes a head 314 including a pair of diametrically opposed flexible locking tabs 316 protruding outwardly from the exterior surface thereof.

Each of the terminals/connectors 310 and 312 further includes an elongate body 318 unitary with the head 314 and defining an interior elongate cradle or recess adapted to receive the respective ends 148a and 148b of the haptic motor power connection cable 148 as described in more detail below. The body 318 further includes first and second pairs of flexible and bendable wings 330 and 332 extending unitarily outwardly from opposed longitudinally extending peripheral top edges of the body 318. The pair of wings 330 are positioned in a spaced-apart and diametrically opposed relationship relative to the pair of wings 332.

In accordance with the present invention, during the process of assembling the pedal 10, the haptic motor power cable 148 extending from the haptic vibratory motor 72 and the track 170 on the underside of the pedal arm 12, and more specifically, the distal ends 148a and 148b thereof are fed through the slot 53 defined in the drum 48 of the pedal arm 12 and into the cavity 49 defined in the interior of the drum 40.

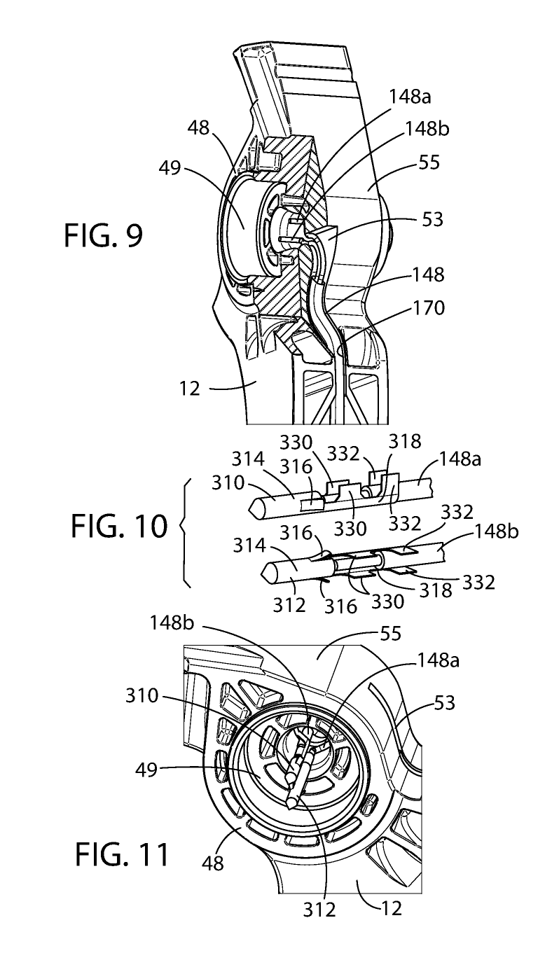

As shown in FIG. 9, it is understood that the ends of the cable 148a and 148b are positioned and situated in the interior recess 49 of the drum 48 of the pedal arm 12 in a relationship wherein a small of amount of loose cable is located in the recess 49 to allow rotation of the pedal arm 12 relative to the pedal housing 14 and the pedal cover 200 during use.

Thereafter, the terminals/connectors 310 and 312 are secured to the respective ends 148a and 148b of the power connection cable 148 as shown in FIG. 11.

In particular, and as shown in FIGS. 10 and 11, the respective ends 148a and 148b of the cable 148 are seated in the respective cradles of the respective bodies 218 of the respective connectors 310 and 312 and the respective wings 330 and 332 of the respective connectors 310 and 312 are bent inwardly towards each other to crimp and secure and electrically couple the ends 148a and 148b of the cable 148 to the respective connectors 310 and 312.

Thereafter, and referring to FIGS. 12 and 13, the respective heads 314 of the respective connectors 310 and 312 are fed through the respective through-holes 203 and 205 extending through the cover 200 and into the interior of the terminal/connector housing 202 on the cover 200.

More specifically, it is understood that upon insertion of the respective heads 314 of the respective connectors 310 and 312 through the respective through holes 203 and 205, the respective flaps 316 flex initially inwardly and then outwardly after the respective flaps 316 clear the respective through-holes 203 and 205 upon further insertion of the respective connectors 310 and 312 to prevent the respective connectors 310 and 312 from sliding back out through the through-holes 203 and 205 into the interior cavity 49 of the drum 49 thereby securing and locking the respective terminals/connectors 310 and 312 in the interior of the connector housing 202 on the cover 200.

The cover 200 is thereafter clipped onto and secured to the side of the housing 14 of the pedal 10 as shown in both FIGS. 1 and 13.

Numerous variations and modifications of the embodiments described above may be effected without departing from the spirit and scope of the novel features of the invention. It is to be understood that no limitations with respect to the specific haptic motor power assemblies illustrated herein are intended or should be inferred. It is, of course, intended to cover by the appended claims all such modifications as fall within the scope of the claims.

What is claimed is:

1. An active vibratory pedal comprising:
a pedal housing;
a pedal housing cover;
a rotatable pedal arm including a first end extending into the pedal housing;
an electric vibratory motor mounted on the pedal arm;
an electric motor power cable extending from the electric motor and into the first end of the pedal arm; and
a motor power connection assembly extending between the first end of the pedal arm and the pedal housing cover.

2. The active vibratory pedal of claim 1 wherein the motor power connection assembly comprises:
electrical contactors coupled to the electric motor power cable and located in the first end of the pedal arm;
electrically conductive tracks formed on the cover of the pedal housing, the electrical contactors being in sliding contact with the conductive tracks; and
an electrical connector housing on the cover including terminals in electrical contact with the conductive tracks.

3. The active vibratory pedal of claim 2 wherein the pedal arm includes a drum defining an open recess, the electrical contactors being located in the open recess in the drum.

4. The active vibratory pedal of claim 3 wherein the haptic motor power connection assembly further comprises a contactor cartridge, the electrical contactors being located in the contactor cartridge and the contactor cartridge extending into the open recess in the drum of the pedal arm.

5. The active vibratory pedal of claim 4 further comprising a printed circuit board on the cover, the conductive tracks being formed on the printed circuit board and the terminals extending into the printed circuit board.

6. The active vibratory pedal of claim 5 further comprising a collar on the cover, the printed circuit board being located on the collar and the collar extending into the open recess defined in the drum of the pedal arm with the electrical contactors in sliding contact against the respective conductive tracks.

7. The active vibratory pedal of claim 1 wherein the motor power connection assembly includes electrical terminals coupled to the end of the motor power cable located in the first end of the pedal arm and extending through through-holes defined in the pedal housing cover.

8. The active vibratory pedal of claim 7 wherein the pedal arm includes a drum defining an open recess, the end of the motor power cable and the electrical terminals being located in the open recess in the drum.

9. An active vibratory pedal comprising:
a pedal housing;
a pedal housing cover;
a rotatable pedal arm including a first end extending into the pedal housing;
an electric vibratory motor mounted on the pedal arm;
an electric motor power cable extending from the electric motor into the first end of the pedal arm; and
a motor power connection assembly comprising:
electrical contactors coupled to the electric motor power cable and located in the first end of the pedal arm;
electrical conductive tracks formed on the cover of the pedal housing, the electrical contactors being in sliding contact with and against the respective conductive tracks in response to the rotation of the pedal arm; and
electrical terminals on the cover in electrical contact with the conductive tracks.

10. The active vibratory pedal of claim 9 wherein the pedal arm includes a drum defining an open recess, the electrical contactors being located in the open recess in the drum.

11. The active vibratory pedal of claim 10 wherein the haptic motor power connection assembly further comprises a contactor cartridge, the electrical contactors being located in the contactor cartridge and the contactor cartridge extending into the open recess in the drum of the pedal arm.

12. The active vibratory pedal of claim 11 further comprising a printed circuit board on the cover, the conductive tracks being formed on the printed circuit board and the terminals extending into the printed circuit board.

13. The active vibratory pedal of claim 12 further comprising a collar on the cover, the printed circuit board being located on the collar and the collar extending into the open recess defined in the drum of the pedal arm with the electrical contactors in sliding contact with the respective conductive tracks.

14. An active vibratory pedal comprising:
a pedal housing;
a rotatable pedal arm including a first end extending into the pedal housing;
an electric vibratory motor mounted on the pedal arm;
a electrical power connection cable extending from the electric motor and including an end extending into the first end of the pedal arm; and
a motor power connection assembly including a pedal housing cover including terminals extending therethrough and coupled to the end of the power connection cable extending into the first end of the pedal arm.

15. The active vibratory pedal of claim 14 wherein the pedal arm includes a drum defining an open recess, the end of the motor power cable and the terminals extending into the open recess in the drum.
